(19) United States
(12) Patent Application Publication
(10) Pub. No.: US 2026/0231001 A1
(43) Pub. Date: Aug. 6, 2026

(54) NETWORK MAPPING OF POLICY SECTIONS IN A WIRELESS COMMUNICATION NETWORK

(71) Applicant: LENOVO (SINGAPORE) PTE. LTD., Singapore (SG)

(72) Inventors: Dimitrios KARAMPATSIS, Ruislip (GB); Roozbeh ATARIUS, La Jolla, CA (US); Genadi VELEV, Darmstadt (DE)

(21) Appl. No.: 19/152,541

(22) PCT Filed: May 15, 2023
(86) PCT No.: PCT/EP2023/063030

§ 371 Date: Jul. 31, 2025

(30) Foreign Application Priority Data
Apr. 4, 2023 (GR) 20230100286

(51) Int. Cl. H04W 48/08; H04W 60/00

(52) U.S. Cl. CPC H04W 48/08; H04W 60/00

(57) ABSTRACT

There is provided a method in a first network function of a first wireless communication network, the method comprising determining for a wireless communication device a policy configuration, the policy configuration indicating one or more policies to be applied by the wireless communication device in a second wireless communication network, and including the policy configuration in a separate policy section identified by a unique policy section identifier; and transmitting the policy configuration to a second network function of the first wireless communication network.

### FIELD

The subject matter disclosed herein relates generally to the field of implementing network mapping of policy sections in a wireless communication network. This document defines a first network function, a method in a first network function, a wireless communication device, and a method in a wireless communication device.

### INTRODUCTION

Since Release 15 onwards UE route selection policy (URSP) rules have been defined to allow a UE to determine how to route application traffic via the mobile communication network either via 3GPP access or via non-3GPP access via an untrusted or trusted WLAN access or route the traffic non-seamlessly bypassing the mobile communication network via a WLAN connection. The URSP rules contain a Traffic Descriptor that allows the UE to determine if a URSP rule matches the application traffic that the UE is currently handling in uplink and/or downlink. Traffic Descriptors may include Application Descriptors (OSID/OSAppID) and IP flow descriptors. IP flow descriptors may be, for example, target address of application traffic, a requested DNN by the application or a connection capability requested by an application (e.g. an IMS connection).

Each URSP rule contains a Route Selection Descriptor (RSD) that defines how the UE is to route the PDU session. The RSD includes one or more of the following: SSC Mode Selection, Network Slice Selection, DNN Selection, PDU Session Type Selection, Non-Seamless Offload indication, Access Type preference. The UE routes the traffic via the PDU session that matches the RSD components. The routes may include both 3GPP access and non-3GPP access.

Currently URSP rules are only provided to a UE from the PCF of the Home PLMN (i.e. H-PCF). A UE uses the provisioned URSP rules in any PLMN that the UE may register to, for example, when the UE is roaming to a Visited PLMN, the UE will apply the same URSP rules in the Visited PLMN as where provisioned by the Home PLMN. However, conventionally a Home PLMN will issue URSP rules suitable for traffic on the Home PLMN without consideration for any Visited PLMN that the UE may use. When the UE is roaming the PCF at the V-PLMN (i.e. V-PCF) is not allowed to create/provision URSP rules but is allowed to create/provision ANDSP (Access Network Discovery and Selection Policy) rules.

### SUMMARY

In convention wireless communication networks, URSP rules are provided only by the H-PLMN and the UE applies the same URSP rules in any PLMN that the UE registers to. This creates issues in case, when a UE is roaming, as the V-PLMN operator may require a specific traffic routing for a specific application. In addition, there are scenarios where a V-PLMN operator cannot interface with the H-PLMN (e.g. in case a UE registers in an SNPN with credentials from the H-PLMN).

Disclosed herein are procedures for network mapping of policy sections in a wireless communication network. Said procedures may be implemented by a first network function, a method in a first network function, a wireless communication device, and a method in a wireless communication device.

Accordingly, there is provided a first network function of a first wireless communication network, the first network function comprising a processor and a memory coupled with the processor. The processor configured to cause the first network function to: determine for a wireless communication device a policy configuration, the policy configuration indicating one or more policies to be applied by the wireless communication device in a second wireless communication network, and including the policy configuration in a separate policy section identified by a unique policy section identifier; and transmit the policy configuration to a second network function of the first wireless communication network.

As such, a first wireless communication network is able to indicate to the wireless communication device in which wireless communication networks the wireless communication device can use policies that are issued from the first wireless communication network. This may be facilitated by providing a mapping of policy sections to wireless communication network identity.

There is further provided a method in a first network function of a first wireless communication network, the method comprising: determining for a wireless communication device a policy configuration, the policy configuration indicating one or more policies to be applied by the wireless communication device in a second wireless communication network, and including the policy configuration in a separate policy section identified by a unique policy section identifier; and transmitting the policy configuration to a second network function of the first wireless communication network.

There is further provided a wireless communication device comprising a processor and a memory coupled with the processor. The processor is configured to cause the wireless communication device to: send a registration request to a wireless communication network, the registration request including a policy container including an indication that the wireless communication device is able to apply different policies in different wireless communication networks.

There is further provided a method in a wireless communication device, the method comprising sending a registration request to a wireless communication network, the registration request including a policy container including an indication that the wireless communication device is able to apply different policies in different wireless communication networks.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for network mapping of policy sections in a wireless communication network will now be described, by way of example only, with reference to the accompanying drawings, in which:

FIG. 1 depicts an embodiment of a wireless communication system for network mapping of policy sections in a wireless communication network;

FIG. 2 depicts a user equipment apparatus that may be used for implementing the methods described herein;

FIG. 3 depicts further details of the network node that may be used for implementing the methods described herein;

FIG. 4 illustrates a modified version of a Classmark;

FIG. 5 illustrates a method for delivering policy section to PLMN configuration mapping to a UE;

FIG. 6 illustrates a method in a first network function of a first wireless communication network; and

FIG. 7 illustrates a method in a wireless communication device.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

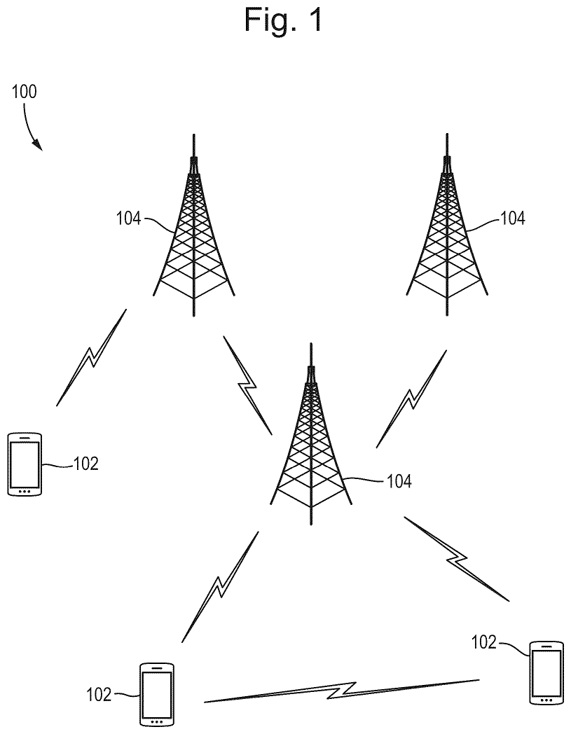

FIG. 1 depicts an embodiment of a wireless communication system 100 for network mapping of policy sections in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

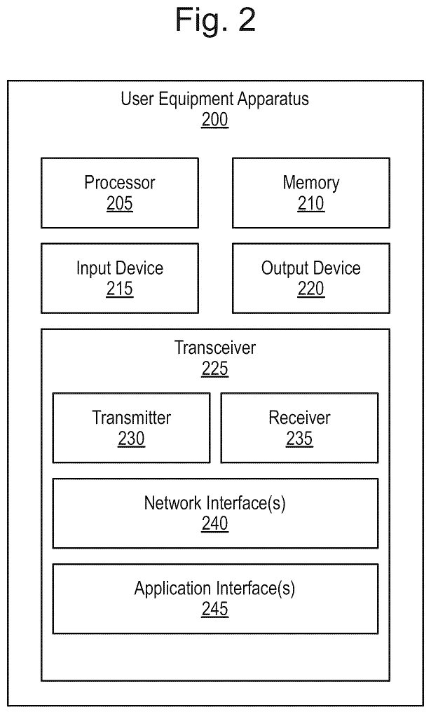

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a wireless communication device as described herein. The user equipment apparatus 200 may comprise a UE 510 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PCS, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module.

Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

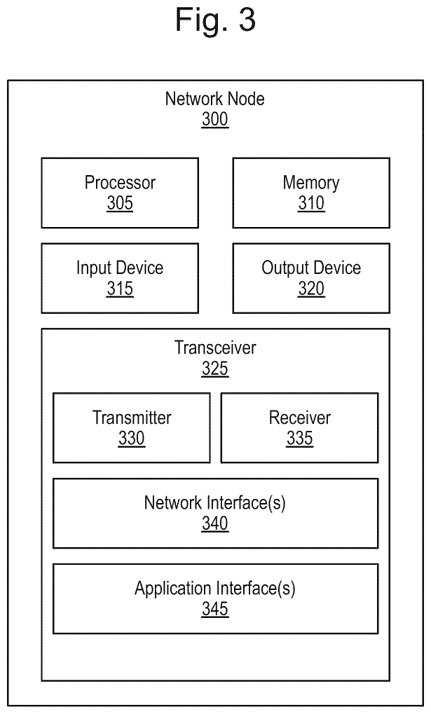

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a first network function as described herein. The network node 300 may comprise a Policy Control Function 530 as described herein. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

Since Release 15 onwards UE route selection policy (URSP) rules have been defined to allow a UE to determine how to route application traffic via the mobile communication network either via 3GPP access or via non-3GPP access via an untrusted or trusted WLAN access or route the traffic non-seamlessly bypassing the mobile communication network via a WLAN connection. The URSP rules and the procedures for the UE to apply URSP rules are described in 3GPP TS 23.502 v18.0.0 (December 2022) titled “Procedures for the 5G System (5GS)” and 3GPP TS 23.503 v18.0.0 (December 2022) titled “Policy and charging control framework for the 5G System (5GS); Stage 2” (URSP rules definitions and procedures are included from version 15.0.0 onwards of 23.502 and 23.503).

The URSP rules contain a Traffic Descriptor that allows the UE to determine if a URSP rule matches the application traffic that the UE is currently handling in uplink and/or downlink. Traffic Descriptors may include Application Descriptors (OSID/OSAppID) and IP flow descriptors. IP flow descriptors may be, for example, target address of application traffic, a requested DNN by the application or a connection capability requested by an application (e.g. an IMS connection).

Each URSP rule contains a Route Selection Descriptor that defines how the UE is to route the PDU session. The RSD includes one or more of the following: SSC Mode Selection, Network Slice Selection, DNN Selection, PDU Session Type Selection, Non-Seamless Offload indication, Access Type preference. The UE routes the traffic via the PDU session that matches the RSD components. The routes may include both 3GPP access and non-3GPP access.

Currently URSP rules are only provided to a UE from the PCF of the Home PLMN (i.e. H-PCF). A UE uses the provisioned URSP rules in any PLMN that the UE may register to, for example, when the UE is roaming to a Visited PLMN, the UE will apply the same URSP rules in the Visited PLMN as where provisioned by the Home PLMN. However, conventionally a Home PLMN will issue URSP rules suitable for traffic on the Home PLMN without consideration for any Visited PLMN that the UE may use. When the UE is roaming the PCF at the V-PLMN (i.e. V-PCF) is not allowed to create/provision URSP rules but is allowed to create/provision ANDSP (Access Network Discovery and Selection Policy) rules.

The H-PCF provisions the UE with URSP and/or ANDSP policies within UE Policy information that is provided to the UE via NAS signalling. The H-PCF allocates the URSP and ANDSP rules within policy sections within the UE policy information each policy section identified by a specific policy section identifier. The H-PCF stores the policy sections and policy section identifier in a database which is used as a means for the H-PCF to determine if the UE requires updated policies. When the UE registers with the PLMN, the UE includes in the registration request the policy section identifiers associated with the policy sections stored in the UE that allows the PCF (both in VPLMN and HPLMN) to identify if updated policies are required at the UE.

As part of Release 18 work in eUEPO work item it has been agreed to allow a solution where the network indicates to the UE which URSP rules are applicable when a UE is roaming to a V-PLMN. This is supported by the home network (i.e. H-PCF) providing a mapping of policy section identifiers to a list of one or more V-PLMN identifiers. When the UE registers to a V-PLMN the UE uses the UE policies for that V-PLMN as higher priority as compared to other URSP rules.

There is provided herein an improvement to the operation of a wireless communication network whereby:
the PCF is made aware, on a per UE basis, the mapping of policy section identifier to a PLMN identifier; and
the mapping of policy section identifier to PLMN identifier is encoded within provisioned UE policies.

3GPP TS 23.503 v18.0.0 (December 2022) titled “Policy and charging control framework for the 5G System (5GS); Stage 2” states that the PCF may provide a mapping of policy section identifier(s) to a PLMN ID. Such a PCF may provide to the UE the tuple (PLMN ID, list of PSIs associated with the PLMN ID) and the Policy Sections containing URSP Rules. However, the standard does not provide details on how the PCF might encode the tuple or how this tuple might be provided.

There is provided herein a tuple included in a separate independent policy section. The tuple comprises PLMN ID and a list of PSIs associated with the PLMN ID.

The solution presented herein includes the mapping of a policy section identifier (or PSI) to a V-PLMN within a policy section in policies that are provisioned to the UE. For simplicity, such policies may be defined herein as “per PLMN policy section configuration” policies.

Such a policy section is configured to indicate that the contents include per PLMN policy section configuration policies. The policy section may identify a route selection policy and a wireless communication network to which the policy section is to be applied. The UE policy part type defined in Table D.6.2.7 of 3GPP TS 24.501 v18.1.0 January 2023) titled “Non-Access-Stratum (NAS) protocol for 5G System (5GS); Stage 3” defines the types of policies. Such a UE policy part is modified to include a new binary encoding to identify “per PLMN policy section configuration” rules (PPPSC rules) as shown in Table 1 below and highlighted with bold and italicized text.

TABLE 1
Encoding of PPPSC information within a policy section
This field contains the binary encoding of the UE
policy part contents length in units of octets.
UE policy part type (bits 4 to 1 of octet q + 2)

| Bits | | | | |
|---|---|---|---|---|
| 4 | 3 | 2 | 1 | |
| 0 | 0 | 0 | 0 | Reserved |
| 0 | 0 | 0 | 1 | URSP |
| 0 | 0 | 1 | 0 | ANDSP |
| 0 | 0 | 1 | 1 | V2XP |
| 0 | 1 | 0 | 0 | ProSeP |
| 0 | 1 | 0 | 1 | Per PLMN policy section configuration |

All other values are reserved.

A policy section as described herein could include one or more of the following pieces of information:
UE Route Selection Policies (URSP) rules;
Access and Network Discovery Policies (ANDSP) rules (including SSIDs that are applicable for each PLMN);
V2X policies (V2XP) rules;
ProSe Policy (ProSeP) rules; and/or
“Per PLMN policy section configuration” containing a mapping of policy section identifier to PLMN identifiers (as described herein).

The PCF may ensure that each policy section contains one type of rule, i.e. either URSP rules, ANDSP, V2X, ProSe Policy or Per PLMN Policy Section Configuration.

The per PLMN policy section configuration (PPPSC) includes, for each policy section identifier (PSI), a list of PLMNs where the UE should apply the rules within the policy section. The PCF ensures that the policy section identifier (PSI) in that list is a part of the policy section identifiers associated with a policy section provisioned to the UE.

When the PCF provides per PLMN policy section configuration (PPPSC) the PCF includes such policies in a policy section identified by a particular PSI. The PCF may store the PSI in the UDR within the policy set entry data identified by the SUPI of the UE, ensuring that this UE always has consistent per PLMN policy section configuration (PPPSC), every time the UE registers in a PLMN. For example, if all stored UE policies are deleted at the UE (e.g. due to the UE switching on/off) then during initial registration with the PLMN, the UE will not include any PSIs in the registration request which will allow the PCF to determine based on the registration request and the information stored in the UDR that the UE needs to be provisioned with UE policies (including PPPSC) The policies provisioned to the UE are based on the information stored in the UDR.

When the UE receives a per PLMN policy section configuration (PPPSC) as part of the UE policies sent to it by the PCF, then the UE constricts a prioritized list of policy sections for each PLMN based on the policy section identifier(s) in the per PLMN policy section configuration. Route selection policy rules that are identified as being specific to a particular PLMN are applied by the UE with a higher priority than route selection policy rules that are not so identified, when the UE is registered to the particular PLMN.

To facilitate implementation of the per PLMN policy section configuration rules, the UE may be arranged to indicates to the PCF support of receiving and applying such rules. The UE may indicate support for receiving per PLMN Policy Section Configuration (PPSC) when the UE registers to the 5G network. For example, the UE may include a Per PLMN Policy Section Configuration capability within a policy container in the initial registration request.

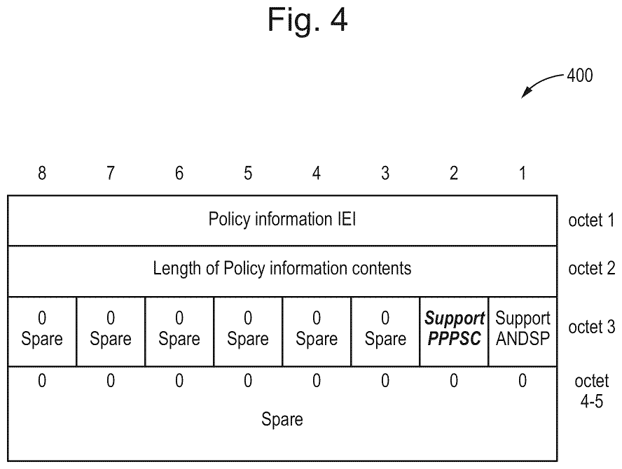

The UE may include the indication of supporting PPPSC rules at initial registration within a UE Policy Classmark information element when the UE sends a UE state indication message in the registration request. A conventional UE Policy Classmark is described in 3GPP TS 24.501 clause D.6.5.1. A modified version of this Classmark 400 is illustrated in FIG. 4.

The classmark 400 comprises a first octet comprising a Policy information Information Element Identifier (IEI) and a second octet comprising the length of policy information elements. The classmark 400 comprises a third octet that includes a filed “SupportANDSP”. The classmark 400 as described herein is modified to include a field in the third octet “SupportPPPSC” highlighted with bold and italicized text.

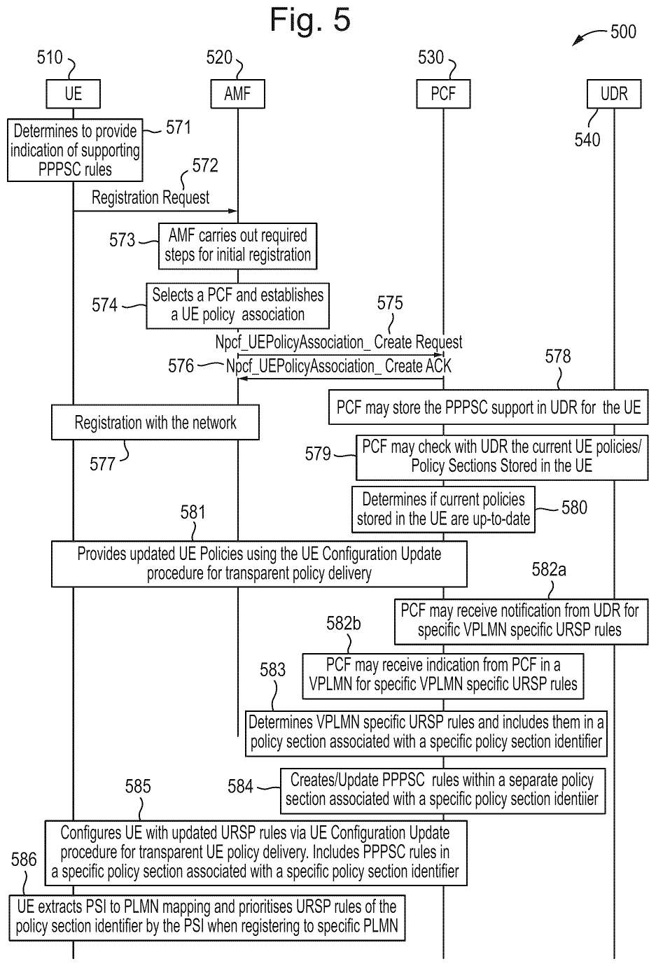

FIG. 5 illustrates a method 500 for delivering policy section to PLMN configuration mapping to a UE. The method 500 is implemented by a UE 510, an AMF 520, a PCF 530 and a UDR 540. The UE 510 may comprise a wireless communication device as described herein. The UE 510 may comprise a user equipment apparatus 200 as described herein. The PCF 530 may comprise a first network function as described herein. The PCF 530 may comprise a network node 300 as described herein.

The process 500 begins at 571, the UE 510 decides to register to a 5G network. The UE 510 is configured to support PPPSC rules.

At 572, as the UE 510 is configured to support PPPSC rule (or capability to support applying URSP rules in a V-PLMN). The UE 510 includes within a registration request a policy container which includes a policy section identifier and an indication that PPPSC rules are supported. The UE 510 also includes in the registration request a list of policy section identifiers if the UE 510 has policies stored.

At 573, the AMF 520 carries out the registration procedure as described in 3GPP TS 23.502 v18.0.0 (December 2022) titled “Procedures for the 5G System (5GS)”.

At 574, at one point in the registration procedure the AMF 520 selects a PCF 530 (for UE 510 policies) as described in 3GPP TS 23.502 v18.0.0.

At 575, the AMF 520 establishes a UE 510 policy association with the selected PCF 530 by sending an Npcf_UEPolicyAssociation Create request. The AMF 520 includes the policy container received by the UE 510.

At 576, the PCF 530 acknowledges the establishment of a UE 510 policy association.

At 577, the procedure for the UE 510 registration continues as described in 3GPP TS 23.502 v18.0.0.

At 578, the PCF 530 may store in the UDR 540 the capability for the UE 510 to support PPPSC rules (or capability to support applying URSP rules in a specific V-PLMN).

At 579, the PCF 530 may check with the UDR 540 the current UE 510 policies/policy sections stored in the UE 510 (based on the policy section identifier).

At 580, based on the information provided by the UE 510 (PSI identifier) and the information provided by the UDR 540, the PCF 530 determines if the UE 510 requires updated UE 510 policies (i.e. compares PSIs sent by the UE 510 and retrieved by the UDR 540).

At 581, if the PCF 530 determines updated UE 510 policies are needed (e.g. UDR 540 information indicating that some policy sections are not stored in the UE 510, or based on updated subscription information) the PCF 530 sends updated UE 510 policies by triggering the UE 510 Configuration Update for transparent policy delivery as described in section 4.2.4.3 of 3GPP TS 23.502 v18.0.0. UE 510 policies may include Policy Sections identified by a PSI identifier that contains PPPSC rules. The PCF 530 may determine to create PPPSC rules based on the PPPSC capability reported by the UE 510 or based on the PPPSC capability retrieved from the UDR 540.

At 582a, the UDR 540 may notify PCF 530 of VPLMN specific URSP rules for one or more VPLMNs identified by a VPLMN identifier (as per description in 3GPP TS 23.502 v18.0.0).

At 582b, the PCF 530 may receive from a PCF 530 in a V-PLMN a request for V-PLMN specific URSP rules.

At 583, the PCF 530 determines V-PLMN specific URSP rules and includes them in a policy section (containing URSP rules only) associated with a policy section identifier. The PCF 530 assigns the policy section identifier.

At 584, the PCF 530 includes a mapping of policy section identifier (of the policy section that includes VPLMN specific rules) to a list of VPLMN identifier(s) based on the information provided in steps 581a/581b and includes them within PPPSC rules. The PCF 530 includes the PPPSC rules in a separate policy section (that contains only PPPSC rules) that is associated to a policy section identifier. The PCF 530 assigns the policy section identifier. If existing policy section that contains PPPSC rules exists (i.e. the UE 510 is already provisioned with such rules) the PCF 530 updates the PPPSC rules with the updated information and my include the updated rules in the existing policy section containing PPPSC rules.

At 585, the PCF 530 sends updated UE 510 policies by triggering the UE 510 Configuration Update for transparent policy delivery as described in section 4.2.4.3 of 3GPP TS 23.502 v18.0.0. UE 510 policies include Policy Sections identified by a PSI identifier that contains PPPSC rules.

At 586, the UE 510 extracts the mapping of PSI to PLMN identifier from the PPPSC rules and prioritizes the URSP rules of the policy section(s) identified by a PSI when registered to a PLMN according to the mapping information.

Accordingly, there is provided a first network function of a first wireless communication network, the first network function comprising a processor and a memory coupled with the processor. The processor configured to cause the first network function to: determine for a wireless communication device a policy configuration, the policy configuration indicating one or more policies to be applied by the wireless communication device in a second wireless communication network, and including the policy configuration in a separate policy section identified by a unique policy section identifier; and transmit the policy configuration to a second network function of the first wireless communication network.

As such, a first wireless communication network is able to indicate to the wireless communication device in which wireless communication networks the wireless communication device can use policies that are issued from the first wireless communication network. This may be facilitated by providing a mapping of policy sections to wireless communication network identity.

The first network function may comprise a Policy Control Function (PCF). The second network function may comprise an Access and Mobility management Function (AMF).

A policy applied by the wireless communication device may be a UE policy. A policy applied by the wireless communication device may be a route selection policy rule. The route selection policies may be UE Routing Selection Policy (URSP) rules.

The wireless communication device may comprise a UE. The UE may be defined according to 3GPP.

A wireless communication network may be identified by a Public Land Mobile Network (PLMN) identifier. The first wireless communication network may be a home wireless communication network. The second wireless communication network may be a visited wireless communication network.

The processer may be further arranged to receive an indication of a list of route selection policies for a wireless communication device the list of route selection policies including an indication of the identity of a wireless communication network in which each route selection policy should be applied.

Each policy configuration may include a tuple containing a Policy Section Identifier and a wireless communication network identifier. The Policy Section Identifier may be associated with a wireless communication network identifier. The wireless communication network identifier may be associated with a Policy Section Identifier.

Each policy configuration may be defined as a new rule within a policy section. The policy configuration for the wireless communication device may be determined based on the stored policies identified by a policy section identifier received by the wireless communication device during a registration procedure. The configuration may be specific to a wireless communication network. The configuration may be specific to more than one wireless communication networks. For example, the wireless communication device may send a list of policy section identifiers (corresponding to the stored policies) and based on that list the first network function may determine that the wireless communication device does not have a policy section that includes the per wireless communication network configuration.

The processer may be further arranged to determine the policy configuration that indicates one or more policies based on receiving information indicating that the wireless communication device is able to apply different policies in different wireless communication networks. The information indicating that the wireless communication device is able to apply different policies in different wireless communication networks may be received from a Unified Data Repository (UDR).

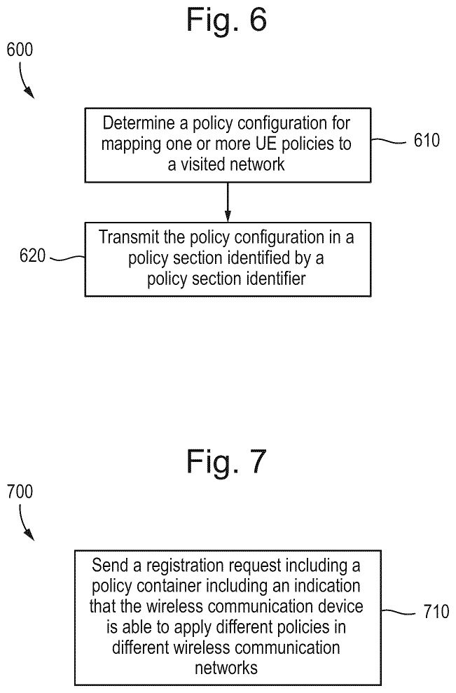

FIG. 6 illustrates a method 600 in a first network function of a first wireless communication network, the method comprising: determining 610 for a wireless communication device a policy configuration, the policy configuration indicating one or more policies to be applied by the wireless communication device in a second wireless communication network, and including the policy configuration in a separate policy section identified by a unique policy section identifier; and transmitting 620 the policy configuration to a second network function of the first wireless communication network.

As such, a first wireless communication network is able to indicate to the wireless communication device in which wireless communication networks the wireless communication device can use policies that are issued from the first wireless communication network. This may be facilitated by providing a mapping of policy sections to wireless communication network identity.

In certain embodiments, the method 600 may be performed by a processor executing program code, for example, a microcontroller, a microprocessor, a CPU, a GPU, an auxiliary processing unit, a FPGA, or the like.

The first network function may comprise a Policy Control Function (PCF). The second network function may comprise an Access and Mobility management Function (AMF).

A policy applied by the wireless communication device may be a UE policy. A policy applied by the wireless communication device may be a route selection policy rule. The route selection policies may be UE Routing Selection Policy (URSP) rules.

The wireless communication device may comprise a UE. The UE may be defined according to 3GPP.

A wireless communication network may be identified by a Public Land Mobile Network (PLMN) identifier. The first wireless communication network may be a home wireless communication network. The second wireless communication network may be a visited wireless communication network.

The method may further comprise receiving an indication of a list of route selection policies for a wireless communication device the list of route selection policies including an indication of the identity of a wireless communication network in which each route selection policy should be applied.

Each policy configuration may include a tuple containing a Policy Section Identifier and a wireless communication network identifier. The Policy Section Identifier may be associated with a wireless communication network identifier. The wireless communication network identifier may be associated with a Policy Section Identifier.

Each policy configuration may be defined as a new rule within a policy section.

The policy configuration for the wireless communication device may be determined based on the stored policies identified by a policy section identifier received by the wireless communication device during a registration procedure.

The configuration may be specific to a wireless communication network. The configuration may be specific to more than one wireless communication networks. For example, the wireless communication device may send a list of policy section identifiers (corresponding to the stored policies) and based on that list the first network function may determine that the wireless communication device does not have a policy section that includes the per wireless communication network configuration.

The method may further comprise determining the policy configuration that indicates one or more policies based on receiving information indicating that the wireless communication device is able to apply different policies in different wireless communication networks. The information indicating that the wireless communication device is able to apply different policies in different wireless communication networks may be received from a Unified Data Repository (UDR).

There is further provided a wireless communication device comprising a processor and a memory coupled with the processor. The processor is configured to cause the wireless communication device to: send a registration request to a wireless communication network, the registration request including a policy container including an indication that the wireless communication device is able to apply different policies in different wireless communication networks.

As such, a wireless communication device is able to receive from the first wireless communication network an indication of the wireless communication networks in which the wireless communication device can use policies that are issued from the first wireless communication network. This may be facilitated by provisioning a mapping of policy sections to wireless communication network identity.

A policy applied by the wireless communication device may be a UE policy. A policy applied by the wireless communication device may be a route selection policy rule. The route selection policies may be UE Routing Selection Policy (URSP) rules.

The processer may be further arranged to store an indication that the wireless communication device is able to apply different policies in different wireless communication networks within a wireless communication device policy classmark information element.

The registration request may be sent to a first network function. The indication that the wireless communication device is able to apply different route selection policy rules in different wireless communication networks may be received by the PCF and may be stored in the UDR by the PCF.

FIG. 7 illustrates a method 700 in a wireless communication device, the method 700 comprising sending 710 a registration request to a wireless communication network, the registration request including a policy container including an indication that the wireless communication device is able to apply different policies in different wireless communication networks.

As such, a wireless communication device is able to receive from the first wireless communication network an indication of the wireless communication networks in which the wireless communication device can use policies that are issued from the first wireless communication network. This may be facilitated by provisioning a mapping of policy sections to wireless communication network identity.

In certain embodiments, the method 700 may be performed by a processor executing program code, for example, a microcontroller, a microprocessor, a CPU, a GPU, an auxiliary processing unit, a FPGA, or the like.

A policy applied by the wireless communication device may be a UE policy. A policy applied by the wireless communication device may be a route selection policy rule. The route selection policies may be UE Routing Selection Policy (URSP) rules.

The method may further comprise storing an indication that the wireless communication device is able to apply different policies in different wireless communication networks within a wireless communication device policy classmark information element. The registration request may be sent to a first network function.

The indication that the wireless communication device is able to apply different route selection policy rules in different wireless communication networks may be received by the PCF and may be stored in the UDR by the PCF.

In convention wireless communication networks, URSP rules are provided only by the H-PLMN and the UE applies the same URSP rules in any PLMN that the UE registers to. This creates issues in case, when a UE is roaming, as the V-PLMN operator may require a specific traffic routing for a specific application. In addition, there are scenarios where a V-PLMN operator cannot interface with the H-PLMN (e.g. in case a UE registers in an SNPN with credentials from the H-PLMN). Currently there are no details as to how the PLMN may provision URSP-PLMN mapping information to the UE.

There is provided herein a method for the PCF to be aware, on a per UE basis, of the mapping of policy section identifiers to a PLMN. There is further provided a method to encode the mapping of policy section identifiers to PLMN within provisioned UE policies.

Accordingly, a PCF of the H-PLMN (the H-PCF) includes the tuple (PLMN ID, policy section identifiers) in a separate policy section identifier and identified by a policy section identifier.

Accordingly, there is provided a PCF in a first mobile communication network and arranged to: receive an indication of a list of URSP policies for a UE that is applicable for a second mobile communication network identified by a PLMN identifier; determine a per PLMN policy configuration for the UE and including such PLMN configuration in a policy section identified by a policy section identifier; and transmit a first message to a first network function (AMF) the first message including the policy section containing the PLMN policy configuration and the associated policy section identifier.

The per PLMN policy configuration may include a tuple containing Policy Section Identifier and associated PLMN identifier (or vice versa i.e. a PLMN identifier and associated policy section identifier(s).

The per PLMN policy configuration may be defined as a new rule within a policy section.

The PCF may determine per policy configuration information based on the per policy PLMN configuration received by the UE during a registration request.

The PCF may determine per policy configuration information based on receiving from the UDR information indicating the UE is capable to apply URSP rules in a specific PLMN.

There is further provided a UE in a first mobile communication network, the UE arranged to determine to register to a 5G mobile communications network; and send a registration request including in the request a policy container including a capability for supporting per PLMN policy configuration.

The capability may be stored within a UE policy classmark information element.

The policy container containing the per PLMN policy configuration capability may be received by a PCF.

The capability for supporting per PLMN policy configuration may be stored in the UDR by the PCF.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: URSP, UE Routing Selection Policy; PCF, Policy and Charging Function; UE, User Equipment; NEF, Network Exposure Function; UDR, Unified Data Repository; PSI, Policy Section Identifier; and RSD, Route Selection Descriptor.

1. A first network function of a first wireless communication network, the first network function comprising:
at least one memory; and
at least one processor coupled with the at least one memory and configured to cause the first network function to:
determine for a wireless communication device a policy configuration indicating one or more policies to be applied by the wireless communication device in a second wireless communication network, and including the policy configuration in a separate policy section identified by a unique policy section identifier; and
transmit the policy configuration to a second network function of the first wireless communication network.

2. The first network function of claim 1, wherein the at least one processor is further configured to cause the first network function to receive an indication of a list of route selection policies for the wireless communication device, the list of route selection policies including an indication of an identity of a wireless communication network in which each route selection policy should be applied.

3. The first network function of claim 1, wherein each policy configuration includes a tuple containing a Policy Section Identifier and a wireless communication network identifier.

4. The first network function of claim 1 wherein each policy configuration is defined as a new rule within a policy section.

5. The first network function of claim 1, wherein the policy configuration for the wireless communication device is determined based on stored policies identified by a policy section identifier received by the wireless communication device during a registration procedure.

6. The first network function of claim 1, wherein the at least one processor is further configured to cause the first network function to determine the policy configuration that indicates one or more policies based on receiving information indicating that the wireless communication device is able to apply different policies in different wireless communication networks.

7. A method in a first network function of a first wireless communication network, the method comprising:
determining, for a wireless communication device, a policy configuration, the policy configuration indicating one or more policies to be applied by the wireless communication device in a second wireless communication network, and including the policy configuration in a separate policy section identified by a unique policy section identifier; and
transmitting the policy configuration to a second network function of the first wireless communication network.

8. The method of claim 7, further comprising: receiving an indication of a list of route selection policies for the wireless communication device, the list of route selection policies including an indication of an identity of a wireless communication network in which each route selection policy should be applied.

9. The method of claim 7, wherein each policy configuration includes a tuple containing a Policy Section Identifier and a wireless communication network identifier.

10. The method of claim 7, wherein each policy configuration is defined as a new rule within a policy section.

11. The method of claim 7, wherein the policy configuration for the wireless communication device is determined based on stored policies identified by a policy section identifier received by the wireless communication device during a registration procedure.

12. The method of claim 7, further comprising: determining the policy configuration that indicates one or more policies based on receiving information indicating that the wireless communication device is able to apply different policies in different wireless communication networks.

13. A user equipment (UE) for wireless communication, comprising:
at least one memory, and
at least one processor coupled with the at least one memory and configured to cause the UE to:
send a registration request to a wireless communication network, wherein the registration request includes a policy container including an indication that the UE is able to apply different policies in different wireless communication networks.

14. The UE of claim 13, wherein the at least one processor is further configured to cause the UE to store an indication that the UE is able to apply different policies in different wireless communication networks within a wireless communication device policy classmark information element.

15. The UE of claim 13, wherein the registration request is sent to a first network function.

16. A method performed by a user equipment (UE), the method comprising:
sending a registration request to a wireless communication network, wherein the registration request includes a policy container including an indication that the UE is able to apply different policies in different wireless communication networks.

17. The method of claim 16, further comprising: storing an indication that the UE is able to apply different policies in different wireless communication networks within a wireless communication device policy classmark information element.

18. The method of claim 16, wherein the registration request is sent to a first network function.
